(19) United States
(12) Patent Application Publication
(10) Pub. No.: US 2024/0400404 A1
(43) Pub. Date: Dec. 5, 2024

(54) MULTI-TIER INTEGRATED POWER-TO-AMMONIA SYSTEMS

(71) Applicants: Rafal Bernat, Woking (GB); Paolo Brunengo, Woking (GB); Rohit Khurana, Epsom (GB); Roberto Baldini, Raynes Park (GB)

(72) Inventors: Rafal Bernat, Woking (GB); Paolo Brunengo, Woking (GB); Rohit Khurana, Epsom (GB); Roberto Baldini, Raynes Park (GB)

(73) Assignee: Kellogg Brown & Root LLC, Houston, TX (US)

(21) Appl. No.: 18/679,026

(22) Filed: May 30, 2024

Related U.S. Application Data
(60) Provisional application No. 63/505,994, filed on Jun. 2, 2023.

(51) Int. Cl. C01C 1/04; C25B 1/042; C25B 15/08

(52) U.S. Cl. CPC C01C 1/0488; C25B 1/042; C25B 15/083

(57) ABSTRACT

A multi-tier integrated power-to-ammonia system includes a converter for generating ammonia and heat through a reaction involving a compressed mixture of hydrogen and nitrogen gases. The system includes a steam generator that can generate steam using the heat from the reaction, and a reversible solid-oxide system in fluid communication with the steam generator that can separate the steam into oxygen gas and hydrogen gas.

### CROSS REFERENCE TO RELATED APPLICATION

This application claims priority to U.S. Provisional Patent Application having Ser. No. 63/505,994 filed on Jun. 2, 2023 which is incorporated by reference herein.

### TECHNICAL FIELD

The present disclosure relates to methods and systems for converting power to ammonia under efficient conditions and utilizing a hydrogen generation unit, a nitrogen generation unit, and an ammonia synthesis loop. Examples include a power generation unit containing a solid oxide system.

### BACKGROUND

Global warming requires decarbonization of many aspects of human activity, including the fertilizers and ammonia production sectors. Currently, this green ammonia production faces challenges in the market due to large costs of production. One of the challenges lies in the poor energy efficiency of the whole plant with current methods. Ammonia demand is high. Ammonia may be a crucial component in the production of nitrogen-based fertilizers, such as urea and ammonium nitrate. Ammonia is gaining attention as a potential energy carrier and storage medium for renewable energy. To the latter use, ammonia can converted into electricity through fuel cells.

### SUMMARY

Provided herein are systems and methods to address these shortcomings of the art and provide other additional or alternative advantages. Applicant has developed methods and systems with improved integration of the ammonia plant as a whole, including a hydrogen generation unit, a nitrogen generation unit, and an ammonia synthesis loop.

A method is disclosed that may include generating ammonia and heat through a reaction of compressed hydrogen and nitrogen gases. Heat from the reaction may be used to generate pressurized steam.

A method is disclosed that may include extracting nitrogen from air in a nitrogen generation unit to produce nitrogen gas and oxygen enriched air. The oxygen enriched air may be used to adjust a temperature of a reversible solid-oxide system when operated for electrolysis of steam to generate oxygen gas and hydrogen gas. Or the oxygen enriched air may be used as feedstock to the reversible solid-oxide system when operated in a fuel cell mode. The pressurized steam may be supplied to a turbine to generate electrical power and produce decompressed steam, and the decompressed steam may be supplied to a solid oxide electrolysis system to generate oxygen gas and hydrogen gas. The method may include extracting nitrogen from air in a nitrogen generation unit to produce nitrogen gas and oxygen enriched air; using the oxygen enriched air to adjust a temperature of a reversible solid-oxide system when operated for electrolysis of steam to generate oxygen gas and hydrogen gas; and using the oxygen enriched air as feedstock to the reversible solid-oxide system when operated in a fuel cell mode. The method may include compressing a first portion of the nitrogen gas and hydrogen gas; generating ammonia and heat through a reaction of compressed first portion of the nitrogen gas and the hydrogen gas; and supplying a second portion of the nitrogen gas to the reversible solid-oxide system for pressurizing an enclosure of the reversible solid-oxide system containing a plurality of solid-oxide electrolysis cells. The method may also include generating pressurized steam using the heat from the reaction; supplying the pressurized steam to a turbine to generate electrical power and produce decompressed steam; and supplying the decompressed steam to the reversible solid oxide electrolysis system to generate the oxygen gas and the hydrogen gas. The method may also include supplying the electrical power to the reversible solid-oxide system to generate the oxygen gas and the hydrogen gas. The method may also include supplying the electrical power to the nitrogen generation unit to extract nitrogen from the air.

An integrated power to ammonia plant is disclosed that may include a reversible solid-oxide system configured to operate as an electrolyzer to separate steam into hydrogen gas and oxygen gas and configured to operate as a fuel cell to generate electricity; a nitrogen generation unit configured to extract nitrogen from air and to produce nitrogen gas and oxygen enriched air; a hydrogen gas storage device to store a first portion of the hydrogen gas, the hydrogen gas storage device configured to supply the first portion of the hydrogen gas to the reversible solid-oxide system to generate the electricity with the oxygen enriched air produced by the nitrogen generation unit; a compressor configured to produce a compressed mixture of a first portion of the nitrogen gas and a second portion of the hydrogen gas; and an ammonia generation unit to generate ammonia and heat through a reaction of the compressed mixture. The compressor may include a motor that can be powered by the electricity generated by the reversible solid-oxide system operating as the fuel cell. A second portion of the nitrogen gas may be supplied to the reversible solid-oxide system for use in pressurizing an enclosure having a plurality of solid-oxide electrolysis cells, and the first and second portions of the nitrogen gas can be concurrently supplied to the compressor and the reversible solid-oxide system, respectively. The plant may also include a battery that can be charged by the electricity generated by the reversible solid-oxide system. The plant may include a steam generator configured to use a waste heat to heat the steam supplied to the reversible solid-oxide system when operated as an electrolyzer, wherein the waste heat is generated by the reversible solid-oxide system while the reversible solid-oxide system is generating the oxygen gas and the hydrogen gas, or the ammonia generation unit during the reaction of the compressed mixture.

A system is disclosed that includes: a converter for generating ammonia and heat through a reaction involving a compressed mixture of hydrogen and nitrogen gases; a steam generator for generating steam using the heat from the reaction; and a reversible solid-oxide system in fluid communication with the steam generator and configured to separate the steam into oxygen gas and hydrogen gas. The system may include a turbine in fluid communication between and with the steam generator and the reversible solid-oxide system, wherein the turbine is configured to be driven by the steam generated by the steam generator and wherein the reversible solid-oxide system is configured to separate the steam into the oxygen gas and the hydrogen gas after the steam drives the turbine. The system may include a nitrogen generation unit configured to extract nitrogen from air to produce nitrogen gas and oxygen enriched air. First and second fluid transfer structures may be included and configured to convey a first portion of the nitrogen gas and the oxygen enriched air from the nitrogen generation unit, respectively, to the reversible solid-oxide system. The system may include a compressor in fluid communication with the nitrogen generation unit and configured to compress a second portion of the nitrogen gas and a first portion of the hydrogen gas to produce the compressed mixture of hydrogen gas and the oxygen gas, wherein the nitrogen generation unit is configured to concurrently supply the first and second portions of the nitrogen gas to the reversible solid-oxide system and the compressor, respectively. The system may include a pressure and flow controller configured to adjust a pressure of the first portion of the nitrogen gas before the first portion of the nitrogen gas is supplied to the reversible solid-oxide system. The reversible solid-oxide system may include an enclosure containing a plurality of solid-oxide cells and an inlet configured to receive the pressure adjusted first portion of the nitrogen gas.

An apparatus is disclosed that may include a reversible solid-oxide system configured to separate steam into oxygen gas and hydrogen gas; a compressor in fluid communication with the reversible solid-oxide system and configured to compress a mixture of hydrogen and nitrogen gases; and a nitrogen generation unit in fluid communication with the reversible solid-oxide system and the compressor and configured to extract nitrogen from air to produce nitrogen gas and oxygen enriched air, wherein the nitrogen generation unit supplies a first portion of the nitrogen gas to the reversible solid-oxide system and a second portion of the nitrogen gas to the compressor. The apparatus may include a pressure and flow controller in fluid communication with the compressor, the nitrogen generation unit, and the reversible solid-oxide system, wherein the pressure and flow controller is configured to adjust a pressure of the first portion of nitrogen gas before the first portion of the nitrogen gas is supplied to the reversible solid-oxide system. The apparatus may include a converter for generating ammonia and heat through a reaction involving the compressed mixture of hydrogen and nitrogen gases; and a steam generator in fluid communication with the reversible solid-oxide system and configured to heat the steam with the heat from the converter before the heat is provided to the reversible solid-oxide system. The apparatus may include a turbine in fluid communication with and between the reversible solid-oxide system and the steam generator, wherein the turbine is configured to be driven with the steam after the steam is heated, and wherein the reversible solid-oxide system is configured to receive the steam after it passes through the turbine. The apparatus may include a generator configured to be driven by the turbine to generate electrical power, a hydrogen compressor to be driven by the turbine directly by means of mechanical coupling and an electrical power distribution system electrically connected to the generator and configured to receive the electrical power generated by the generator, wherein the electrical power distribution system may be electrically connected to the reversible solid-oxide system and configured to supply electrical power to the reversible solid-oxide system.

An apparatus is disclosed that may include a reversible solid-oxide system configured to operate either as an electrolyzer to separate steam into hydrogen gas and oxygen gas, or as a fuel cell to generate electricity; a nitrogen generation unit configured to extract nitrogen from air to produce nitrogen gas and oxygen enriched air; a storage device for storing hydrogen gas generated by the reversible solid-oxide system while operating as the electrolyzer; and a compressor for compressing a mixture of a first portion of the nitrogen gas produced by the nitrogen generation unit and hydrogen gas generated by the reversible solid-oxide system while operated as the electrolyzer, wherein the reversible solid-oxide system is configured to generate electrical power using hydrogen gas or ammonia from the storage device when operated as the fuel cell.

### BRIEF DESCRIPTION OF THE DRAWINGS

The present disclosure is illustrated by way of example, and not by way of limitation, in the figures of the accompanying drawings in which like reference numerals refer to similar elements.

FIG. 1 is a block diagram illustrating relevant components of an ammonia synthesis plant.

FIG. 2A is a block diagram illustrating relevant aspects of an example of integrated plant as described herein.

FIG. 2B is a schematic diagram illustrating relevant aspects of an example of an enclosure with solid-oxide cell stacks contained in compartments.

FIG. 3 is a block diagram illustrating relevant aspects of the integrated plant of FIG. 2A operating in an electrolysis mode.

FIG. 4 is a block diagram illustrating relevant aspects of the integrated plant of FIG. 2A operating in fuel cell mode.

FIG. 5 is a block diagram illustrating relevant aspects of the integrated plant of FIG. 2A operating in another fuel cell mode.

### DETAILED DESCRIPTION

The following description sets forth numerous specific details such as examples of specific systems, components, methods, and so forth, in order to provide a good understanding of various examples of the techniques described herein.

However, it will be apparent to one skilled in the art that at least some examples may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the spirit and scope of the present disclosure.

Reference in the description to “an example,” “one example,” “some examples,” and “various examples” means that a particular feature, structure, step, operation, or characteristic described in connection with the example(s) is included in at least one example of the disclosure. Further, the appearances of the phrases “an example,” “one example,” “some examples,” and “various examples” in various places in the description do not necessarily all refer to the same example(s).

The description includes references to the accompanying drawings, which form a part of the detailed description. The drawings show illustrations in accordance with examples. These examples are described in enough detail to enable those skilled in the art to practice the claimed subject matter described herein. The examples may be combined, other examples may be utilized, or structural, logical, and electrical changes may be made without departing from the scope and spirit of the claimed subject matter. It should be understood that the examples described herein are not intended to limit the scope of the subject matter but rather to enable one skilled in the art to practice, make, and/or use the subject matter.

Ammonia production may be an energy-intensive and complex industrial process. Specific conditions may vary depending on the specific plant design and desired production output. The process for producing ammonia may include obtaining the needed reactants of nitrogen gas (N₂) and hydrogen gas (H₂). Nitrogen gas may be obtained from the air, while hydrogen gas may be produced from hydrocarbon sources, such as natural gas or methane, or from water (H₂O) using electrolysis.

Some examples may include methods and systems for generating ammonia or electricity utilizing one or more of the following aspects of the disclosure. In a first aspect, waste heat from an ammonia converter may be utilized to generate superheated steam, which may then be decompressed in a steam turbine and/or used in a solid oxide (SO) system as a feedstock for the fuel side of the SO system. In another aspect, oxygen enriched air from a nitrogen generation unit may be utilized as a feedstock for the oxidizer side of an SO system. In another aspect, nitrogen from the nitrogen generation unit may be utilized as an inert medium that pressurizes an enclosure in which the SO system stack or stacks may be mounted. In another aspect, waste heat from the SO system may be utilized for steam production in a steam generator. Another aspect includes a reversible SO system (capable of operation as an electrolyzer and/or as a fuel cell) that allows for consumption of hydrogen from the hydrogen gas storage device and/or ammonia from the ammonia storage as a fuel to maintain production of ammonia of the plant in, e.g., off-grid plant operation mode. One or any combination of the foregoing aspects may be deployed in a power-to-ammonia system. In some examples, all of the aspects may be deployed in an integrated power-to-ammonia system.

Examples of the integrated power-to-ammonia system include multi-tier integration. In examples, the integrated power-to-ammonia system, may include a multi-tier integration including a hydrogen generation unit, a nitrogen generation unit, and an ammonia synthesis loop. In examples, the hydrogen generation unit may involves electrolysis utilizing either an alkaline, a proton exchange membrane, and/or a SO electrolysis cell.

Some examples include generation of feedstock hydrogen and nitrogen for an ammonia synthesis loop. As conversion of hydrogen and nitrogen to ammonia may be an exothermic reaction, an ammonia converter of the loop can generate a large amount of heat, which may be utilized to generate steam. In some arrangements, about one ton of steam may be generated along with one ton of ammonia. A medium pressure steam (about 45 to 60 bar and 300-400° C.) may be at the pressure level at which the steam may be superheated to high temperature with heat generated by the exothermic reaction. Solid-oxide systems can operate at high temperatures ranging from about 600° C. to about 1000° C. In examples, solid oxide systems may require steam at a pressure 1 bar absolute to generate hydrogen and oxygen when operating in electrolysis mode. In some standalone operations of a SO electrolysis system, water may be supplied in a liquid state and evaporated in the evaporator. In examples, the water may be subsequently preheated with exhaust gases of the solid oxide electrolysis system. In examples, a supply of steam generated in the ammonia plant can be split into hydrogen and oxygen by the SO system when operated in electrolysis mode. In some examples, to maximize the energy efficiency of the integrated plant, medium pressure steam (about 45 to 60 bar) produced with waste heat from the SO system and/or the converter system, may be fed to the steam turbogenerator first, where it may be decompressed and subsequently fed as a feedstock to the SO system. Additional steam may be supplied to the SO system along with the decompressed steam from the turbogenerator in an example. In another example, the steam may be fed to a combined single-shaft turbocompressor that pressurizes the effluent hydrogen fed to the ammonia synthesis loop.

Some examples may include the use of oxygen enriched air from a nitrogen generation unit in the oxidizer side of an SO system. The nitrogen generation unit may be an air separation unit. Here, air (about 78% nitrogen and about 21% oxygen) may be used as a feedstock for nitrogen production in a process, where nitrogen may be extracted from the air by cryogenic means, or by pressure swing absorption in which filtered and compressed air is directed into separation columns that absorb oxygen while nitrogen passes and is collected. Other processes for producing nitrogen are contemplated. The air remaining after nitrogen separation may be vented and may contain an increased concentration of oxygen that is kept below 35% threshold to prevent corrosive atmosphere. Examples of this disclosure include supplying the oxygen enriched air to the oxidizer side of the solid oxide system, instead of being released into the atmosphere. In some standalone solid oxide electrolysis systems, air may be supplied to the oxidizer side of the system to help maintain the proper operational temperature. In a fuel cell mode, oxygen may be used for the reaction process. The integration of supply of the oxygen enriched air to the oxidizer side of the solid oxide system can lead to a decreased energy consumption and an increased energy efficiency of the integrated plant.

Some examples may include the use of nitrogen from the nitrogen generation unit to facilitate pressurization of cell stacks. A solid oxide system may operate at a pressure close to atmospheric pressure. When pressurized with inert gas, one should aim to maintain minimum pressure differences (10-20 millibars) in the cell stacks and, ideally, the enclosure, where the stacks may be mounted. Solid oxide system stacks may be subject to thermal stresses. In pressurized operation, the pressure can be controlled to avoid additional stresses due to pressure differences and potential leakages. Outlet pressure from an air separation unit may be at the level ranging from about 7 bar absolute to about 9 bar absolute. In examples, the air separation unit can be configured to facilitate multiple pressure levels. Some examples of the system may include a modified nitrogen generation unit that can be configured to provide nitrogen at about 5 bar to the enclosure around the stacks, where SO system may be present and pressurized to 5 bar as well. In some examples, the solid oxide systems may be pressurized to levels ranging from about 1 bar absolute to about 9 bar absolute, or from about 2 bar absolute to about 8 bar absolute, or from about 3 bar absolute to about 7 bar absolute, or from about 4 bar absolute to about 6 bar absolute, or about 5 bar absolute. In examples, the pressure level of the nitrogen may be increased to facilitate pressurization of the SO stacks to pressure exceeding the abovementioned values.

Some examples may include the use of waste heat from the solid oxide electrolysis system to produce steam and/or preheat media in the ammonia synthesis loop. Solid oxide systems can operate at high temperatures ranging from about 600° C. to about 1000° C. and produce a significant amount of waste heat. In examples, the waste heat from the solid oxide system may be used to preheat reaction substrates or generate district heat. In examples, the system may include a solid oxide system that may be integrated thermally within the ammonia plant. In examples, this arrangement may take advantage of the waste heat in several ways. In examples, the waste heat may be used both for steam generation (that is used subsequently as a feedstock for hydrogen production) and/or to preheat boiler feed water or other media in the plant.

Some examples may include the use of stored hydrogen/ammonia as a fuel to operate green ammonia plant using central process control systems. For example, the integrated power-to-ammonia plant may include a process control system to predict and respond to the fluctuations of the renewable power. In some arrangements of an off-grid green ammonia plant in the art, electrical battery storage systems may be used to provide electricity at times, when it may not be possible to sustain the minimum power that may be required by the ammonia synthesis loop compressions systems, the air separation unit, and other auxiliaries. According to examples disclosed here, stored hydrogen and/or ammonia may be used to produce electricity and heat in all/part of the solid oxide system to generate the required energy to sustain minimum operation of the plant during turndown. These methods and systems can render the use of a battery storage system dispensable and improve stability of the processes. In examples, the inputs to the abovementioned process control system may include but are not limited to: the availability of renewable power below the minimum for the operation of the plant, the hydrogen and ammonia storage levels, reversible SO system current condition, the energy for the operation at turndown, or any combination thereof.

Some examples may result in one or more of the following technical and commercial advantages. For example, there may be a lower capital expenditure resulting from the minimization of number of equipment elements in the solid oxide electrolysis system. The production of steam as a feedstock for the solid oxide electrolysis may result in both lower capital expenditure due to economy of scale from the water production and lower operating expenses as there may be no need or reduced need for energy used for evaporation. There may be also an increased efficiency from the end-to-end ammonia production process. In some examples, the integrated power-to-ammonia plant may operate at reduced expenses. Some examples described here may lower capital expenditure, such as the smaller electrolyzer systems needed for the same ammonia production and systems that render electricity storage systems dispensable.

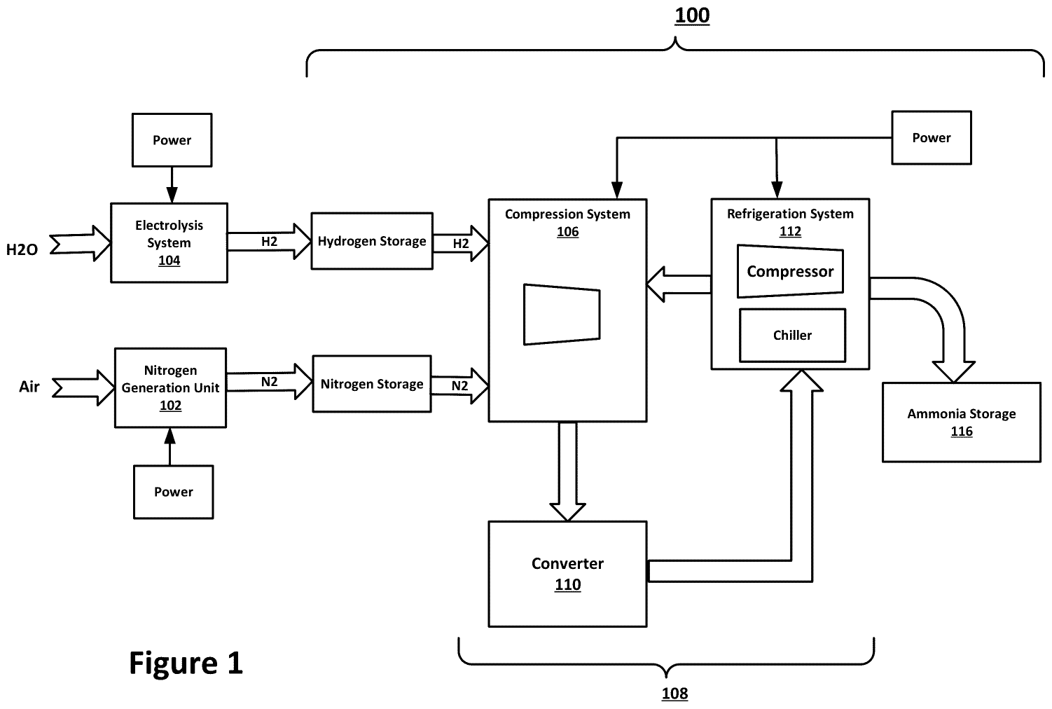

FIG. 1 is a schematic diagram illustrating some components of an example ammonia synthesis section 100 for producing ammonia. FIG. 1 shows a nitrogen generation unit 102 for producing nitrogen gas from air, and an electrolysis system 104 for producing hydrogen gas from water. Ammonia synthesis section 100 includes an ammonia synthesis loop 108, which includes a compression system 106, a converter (e.g., a reactor) 110, and a refrigeration system 112. Through a complex process the ammonia synthesis loop 108 converts nitrogen and hydrogen feedstocks provided by nitrogen generation unit 102 and electrolysis system 104, respectively, and into ammonia. The components of FIG. 1 are described in greater detail below.

A nitrogen generation unit may include a system configured to produce nitrogen gas from an input source of air. Although not shown nitrogen generation unit 102 may consist of several energy consuming components that work together. For example, nitrogen generation unit 102 may include a compressor that compresses ambient air, raising its pressure and temperature. The compressor may include an electric motor. An air treatment system may consist of filters and dryers that remove moisture, and particulate matter from the compressed air to ensure clean and dry air for the nitrogen generation process. An air separation unit may employ any one of various techniques such as pressure swing adsorption (PSA) or membrane separation to separate nitrogen from the compressed air. In PSA systems, carbon molecular sieves or zeolites may be used as adsorbents to selectively adsorb oxygen and other impurities, allowing nitrogen to pass through for subsequent storage in a buffer tank.

Electrolysis may be a promising method of hydrogen production from water due to its efficiency of conversion and relatively low energy input when compared to thermochemical and photocatalytic methods. Like the process employed in nitrogen generation unit 102, the process employed in electrolysis system may be energy intensive. In general, the system produces hydrogen and oxygen through a process called electrolysis, which involves the use of an electrical current to split water molecules into their constituent elements. Electrolysis system 104 may include an anode and cathode immersed in water. The anode and cathode may be connected to a direct current power source that provides the electrical energy to split the water molecules into their constituent components of hydrogen and oxygen. The anode may be connected to the positive terminal of the power source, and the cathode may be connected to the negative terminal of the power source. At the anode, oxidation takes place, resulting in the release of oxygen gas and positively charged hydrogen ions. At the cathode, reduction occurs, causing hydrogen gas to be produced.

The ammonia synthesis loop 108 in the synthesis section 100 may include a compression system 106. In examples, the nitrogen gas provided by the nitrogen generation unit 102 and/or the hydrogen gas provided by the electrolysis system 104 may be compressed. Like nitrogen generation unit 102 and electrolysis system 104, compression system 106 may consume substantial energy to operate. Compression system 106 may include an electric motor that may be operated by electricity. Compression system 106 may raise the pressure of the hydrogen/nitrogen gas mixture to around 80 atmospheres (atm) or higher, which may help increase the chances of successful collisions between the reactant molecules. The compressed gases may be cooled to reduce the temperature. In examples, lowering the temperature of the compressed gases may increase the gas density and enhance the efficiency of subsequent reactions. The compressed gas may be introduced into converter 110. The converter 110 may contain a catalyst bed. In examples, the catalyst bed may include iron-based catalysts, such as iron oxide (Fe₃O₄), combined with promoters like aluminum oxide (Al₂O₃) and potassium oxide (K₂O). Inside the converter 110, nitrogen gas and hydrogen gas meet the catalyst bed. The nitrogen and hydrogen molecules adsorb onto the catalyst's surface, allowing them to react and form ammonia. In examples, the reaction takes place at elevated temperatures, such as above 300 degrees Celsius (° C.) and below 600 degrees Celsius (° C.). In examples, the reaction takes place at high pressures, 80 atm or higher. The reaction may be exothermic. Cooling systems, such as heat exchangers (not shown), may be employed to control the temperature within converter 110. The reaction mixture, containing ammonia, unreacted nitrogen and hydrogen gases, may be cooled to a lower temperature in refrigeration system 112 to condense ammonia. Liquified ammonia may be separated from the unreacted gases using various separation techniques. The unreacted nitrogen and hydrogen gases, along with a portion of the produced ammonia, may be recycled back into the converter 110 thereby completing the process loop within ammonia synthesis loop 108. In examples, this loop 108 may help improve the overall conversion and efficiency of the process. Ammonia may be stored in containers 116. In examples, containers 116 may be used for transportation. In examples, the stored ammonia may be used in various applications, including the production of fertilizers or energy generation.

In examples, the ammonia synthesis loop 108 may be supplied with nitrogen and hydrogen gas from the nitrogen and hydrogen generation units 102 and 104, respectively. In examples, the ammonia synthesis section 100 may be separate from the nitrogen and hydrogen generation units 102 and 104. In examples, sections 100, 102, and 104 are separate units. In examples, sections 100, 102, and 104 are not integrated. In examples, the hydrogen and nitrogen generation units 102 and 104 may be employed as feedstock hydrogen and nitrogen.

The ammonia produced by ammonia synthesis section 100 may be expensive due to the cost of production. One of the reasons for this cost may be that the production energy efficiency of the whole system is, with current methods, still too low. Better integration of the hydrogen generation unit, nitrogen generation unit and the ammonia synthesis unit can improve efficiency. In examples, provided is an advanced multi-tier integrated power-to-ammonia plant. The plant can integrate multiple aspects of ammonia synthesis section, hydrogen generation section, nitrogen generation section, and other sections to create a plant that produces ammonia, hydrogen, and/or electrical power. For example, waste heat from the ammonia converter may be used to generate steam that may be used as feedstock for a reversible solid-oxide system operating as an electrolyzer, after the steam is decompressed by a turbine. The turbine can also be used, for example, to compress hydrogen or to drive a generator for generating electrical power, which in turn can be used for powering the nitrogen generation unit, compressor of the ammonia synthesis loop 108, or other components of the integrated plant. Oxygen enriched air produced by a nitrogen generation unit may be used as feedstock for the reversible solid-oxide system when it operates as a fuel cell to generate electrical power. In addition to providing nitrogen to the ammonia synthesis loop 108, the nitrogen generation unit can provide nitrogen for pressurizing an enclosure of the reversible solid-oxide system that may contain solid-oxide cells or stacks of solid-oxide cells. The enclosure may include an inlet configured to receive pressurized nitrogen gas. One or more the integrations ammonia plant components like those described above may serve to lower the cost and/or increases the efficiency of ammonia production.

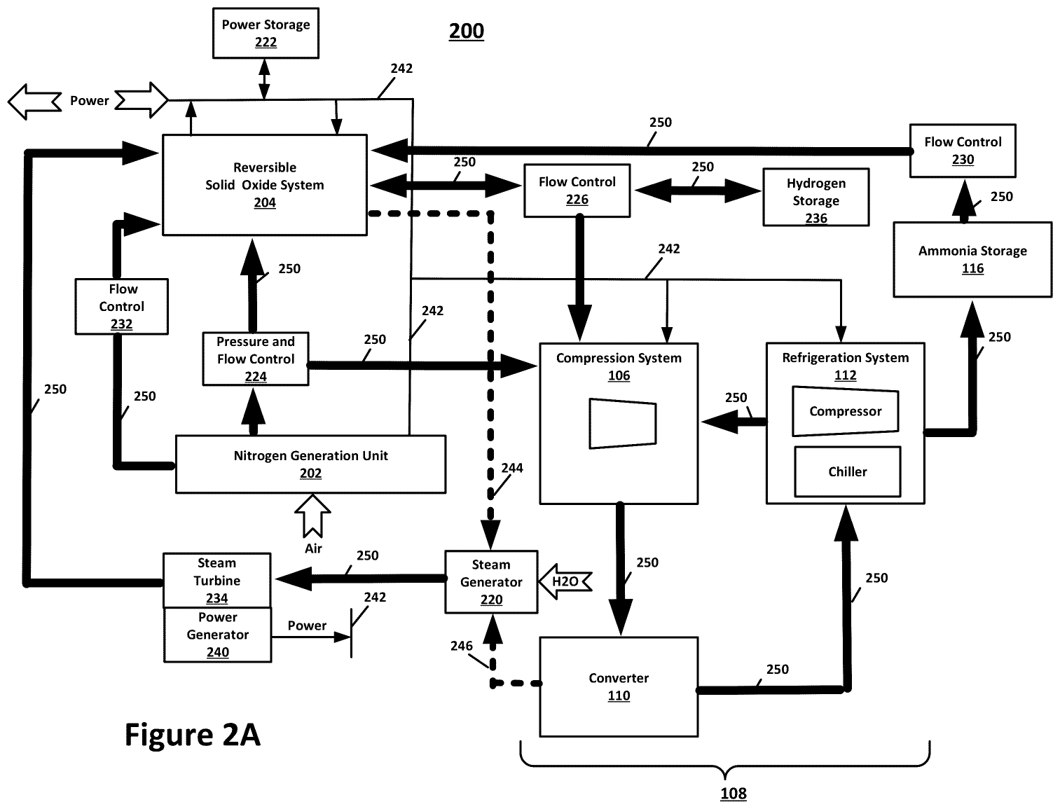

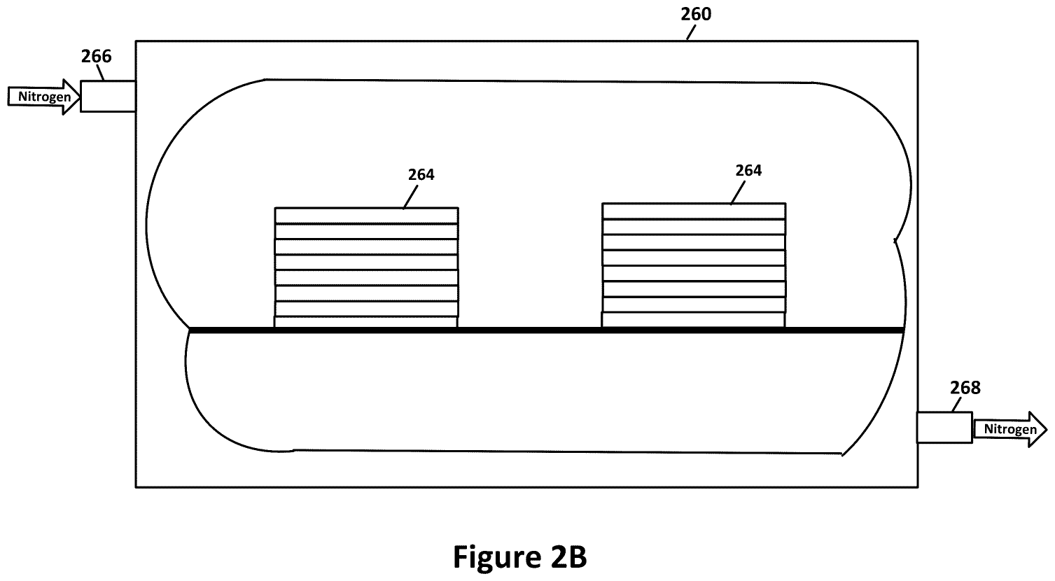

FIG. 2A is a schematic diagram illustrating relevant components of an example multi-tier integrated power-to-ammonia plant 200. This example plant 200 includes three integrated components: a nitrogen generation unit 202 for producing nitrogen gas and oxygen enriched air; a reversible SO system 204 that can be operated as an electrolyzer for producing hydrogen or as a fuel cell for generating electricity (in some examples a portion of the installed system capacity may be reversible), and; an ammonia synthesis loop 108 for producing ammonia that includes compression system 106, converter (e.g., a reactor) 110, and a refrigeration system 112. The compression system 106, converter 110, and refrigeration system 102 employed in plant 200 may be like those employed within synthesis section 100 shown in FIG. 1. Components of plant 200, such as compression system 106 and converter 110, may be in fluid communication with each other through various transfer structures 250 of differing constructions that may include pipes, joint connections, relief valves, monitoring systems, etc.

Plant 200 includes additional integrated components. For example, plant 200 includes a steam generator 220 coupled to heat transfer systems 244 and 246, each of which may include one or more heat exchangers. Conversion of hydrogen and nitrogen to ammonia may be an exothermic reaction, and ammonia converter 110 generates waste heat. Further, SO system 204 may produce a significant amount of waste heat. Heat generated by SO system 204 and/or converter 110 may be transferred to steam generator 220 through heat transfer systems 244 and 246, respectively. Steam generator 220 can use the heat for generating superheated steam. The steam can drive steam turbine system 234, which in turn can drive a power generator for generating electrical power and/or compress the hydrogen product from SO system 204. After passing through turbine 234, the steam has reduced pressure and can be supplied to SO system 204 as feedstock for electrolysis as more fully described below.

In examples, the reversible SO system 204 can switch between operating as an electrolyzer for producing hydrogen gas and operating as a fuel cell for generating electrical power. Reversible SO system 204 may employ SO electrolysis cells (cells) (not shown). A cell may include a solid electrolyte sandwiched between two electrodes—an anode and a cathode. These electrodes may be made of or include conductive materials, such as metals and/or metal oxides. In fuel cell mode, a fuel such as hydrogen or ammonia may be oxidized at the anode, while oxygen from oxygen enriched air supplied by nitrogen generation unit 202 may be reduced at the cathode, thereby generating electricity. The electricity may be used to power one or more components of plant 200 like refrigeration system 112, the electricity may be stored in power storage 222, and/or the electricity may be sold to a utility grid operator. In electrolysis mode, the cells in reversible SO system 204 can be configured to split water in the form of steam into hydrogen and oxygen. Steam may be fed into the porous cathode from a steam generator 220 after the steam passes through steam turbine 234 to reduce its pressure. In some examples additional heat may be needed aside from the heat from than converter 110 and SO system 204 to generate steam for SO system 204. In examples, by applying a voltage between the cathode and anode, it may be possible to cause the steam to move to the cathode-electrolyte interface and to reduce the steam to form hydrogen gas and oxygen ions. In examples, the electrolyte can include a dense enough material to be impermeable to steam and hydrogen gas while conducting oxygen ions. In examples, this may prevent the recombination of the hydrogen gas and oxygen ions. At the electrolyte-anode interface, the oxygen ions may be oxidized to form pure oxygen gas at the surface of the anode. In examples, the hydrogen gas diffuses back up through the cathode and may be collected at the cathode's surface. In example, the collected hydrogen may be transferred to a hydrogen gas storage device 236 and/or to compression system 106 for use in the ammonia synthesis loop 108 via flow controller 226. In examples, the SO electrolyzer cells may operate at temperatures in the range of 600° C.-1000° C. At this elevated temperature it may be possible to achieve ionic conductivity within the solid-state electrolyte, allowing for efficient ion transport and the desired electrochemical reactions to occur. Flow control 232 can control the temperature by controlling the flow of oxygen enriched air provided to solid-oxide system 204 by nitrogen generation unit 202. Stacks of cells may be contained an enclosure of solid-oxide system 204. FIG. 2B is a schematic illustrating an enclosure 260, a portion of which is cut away to reveal a pair of cell stacks 264. Stacks 264 are pressurized. In examples, minimum pressure differences may be maintained in the cell stacks 264 and the enclosure 260 in which they are contained. In examples, the pressure may be controlled using an inert gas. Nitrogen from the nitrogen generation unit 202 may be used for this purpose. Enclosure 260 includes a nitrogen input port 266, and a nitrogen export port 268. Pressure and flow controller 224 can be used to control the pressure of the nitrogen supplied to port 266 and interior space of enclosure 260 of SO system 204. In examples, the outlet pressure from a nitrogen generation unit may be at the level of 7-9 bar abs. Pressure and flow controller 224 can adjust the pressure of the nitrogen to fit the needs of oxide system 204 (e.g., pressure difference of about 10-20 millibar between cell stacks and enclosure). For example, pressure and flow controller 224 can adjust the pressure of nitrogen provided to enclosure to maintain the enclosure at 5 bar. Other pressure levels are contemplated.

Nitrogen generation unit 202 may produce nitrogen gas and/or oxygen enriched air from an input source of air. Although not shown nitrogen generation unit may include several components that work together. In examples, nitrogen generation unit 202 can extract nitrogen from the air by cryogenic means. Some or all of the extracted nitrogen may be supplied to compression system 106 of the ammonia synthesis loop 108 as feedstock. Some of the nitrogen may be supplied to SO system 204 for pressurizing cell enclosures as noted above. In examples, the air that remains after nitrogen extraction may be vented from the nitrogen generation unit 202. In examples, the air that remains post nitrogen extraction may be oxygen enriched air, i.e. it may contain an increased concentration of oxygen. Oxygen enriched air has an oxygen concentration that is higher than 21%. In examples, the oxygen enriched air, instead of being vented, may be selectively fed to reversible SO system 204. Oxygen enriched air can be supplied to SO system 204 to help control the operational temperature of reversible SO system 204. Before the oxygen enriched air is supplied to SO system 204, it can be preheated using, for example, waste heat from converter 110. In examples, the SO system 204 can operate in fuel cell mode to generate electrical power. In fuel cell mode, oxygen may be used for the reaction process. In examples, the nitrogen generation unit 202 can provide the oxygen for the reaction process by supplying the oxygen enriched air to SO system 204.

Plant 200 may include an electrical distribution system 242 for distributing electrical power between various components. Power conversion units (e.g., rectifiers, variable speed controllers, inverters, etc.) may be needed to interface system 242 with the various components to which the electrical distribution system 242 may be electrically connected. In examples, the SO system 204 can act as a source or load of electrical power to electrical distribution system 242 depending upon whether SO system 204 operates in electrolysis or fuel cell mode. Likewise, power storage (e.g., a battery) 222 can act as a source or load of electrical power. A distribution system 242 may be electrically connected to transmit excess power to a utility grid or receive power from the utility grid. Power from generator 240 may be distributed to components like nitrogen generation unit 202 by distribution system 242.

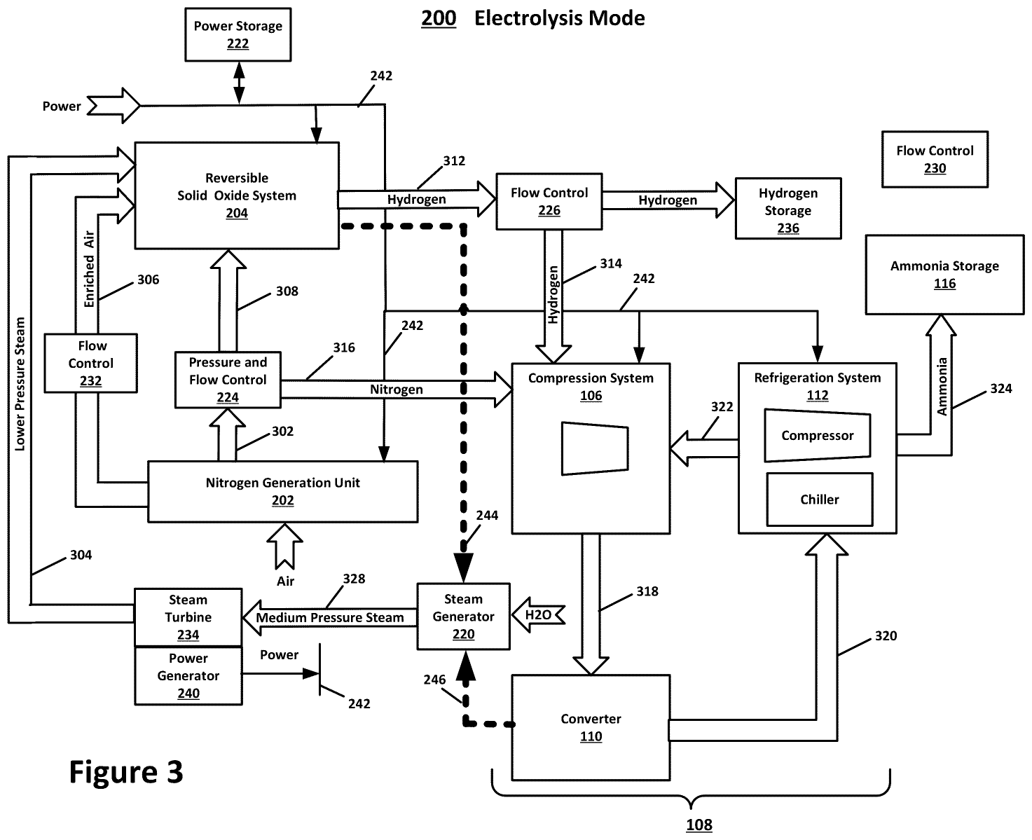

In examples, plant 200 can operate in electrolysis mode. FIG. 3 illustrates an example of plant 200 operating in electrolysis mode. Nitrogen generation unit 202 supplies nitrogen 302 and pressure adjusted nitrogen 304 to compression system 106 and SO system 204, respectively, through pressure and flow controller 224. Nitrogen generation unit 202 can supply oxygen enriched air 306 to system 204 through flow controller 232 for maintaining the temperature of SO system 204. The SO system 204 may be supplied with steam 310 from steam generator 220 after it passes through the steam turbine 234. In examples, the SO system 204 may receive electrical power from the utility grid, power storage 222, and/or power generator 240 via electrical power distribution system 242. The SO system 204 may use the electrical power received to split molecules of the low-pressure steam feedstock 304 into oxygen and hydrogen. The resulting hydrogen 312 flows to compression system 106 as feedstock or stored in a hydrogen gas storage device 236. Flow controller 226 regulates the flow of hydrogen 312 between SO system 204, hydrogen gas storage device 236, and compression system 106.

The ammonia synthesis loop 108 can use the hydrogen provided by SO system 204 and/or hydrogen gas storage device 236 along with nitrogen provided by nitrogen generation unit 202 to produce ammonia for storage in ammonia storage 116. In examples, compression system 106 can receive feedstock hydrogen 314 and nitrogen 316 via flow controller 226 and pressure and flow controller 224, respectively. Here nitrogen gas 316 and hydrogen gas 314 may be mixed and compressed. In examples, compression system 106 may raise the pressure of the hydrogen/nitrogen gas mixture to at least 80 atmospheres (atm). In examples, the pressure can help increase the chances of successful collisions between the reactant molecules. The compressed and cooled nitrogen gas and hydrogen gas may be mixed in a specific ratio, around one part nitrogen to three parts hydrogen. This mixture 318 may be introduced into converter 110. The converter 110 may contain a catalyst bed, made of iron-based catalysts, such as iron oxide (Fe₃O₄), combined with promoters like aluminum oxide (Al₂O₃) and potassium oxide (K₂O). Inside the converter 110, nitrogen gas and hydrogen gas meet the catalyst bed. In examples, the nitrogen and hydrogen molecules adsorb onto the catalyst's surface, allowing them to react and form ammonia. The reaction may take place at elevated temperatures between, for example, 300 and 600 degrees Celsius (° C.), and high pressures of, for example, 80 atm or higher, it being understood that lower pressures are also contemplated. The reaction may be exothermic. Heat from the reaction may be transferred to steam generator 220 through heat transfer system 246, where it may be used to create superheated steam that drives turbine 234. The reaction mixture 320, containing ammonia, unreacted nitrogen and hydrogen gases, may be cooled to a lower temperature in refrigeration system 112 to condense ammonia. Liquified ammonia 324 may be separated from the unreacted gases using various separation techniques. The unreacted nitrogen and hydrogen gases, along with a portion of the produced ammonia (collectively 322), may be recycled back into the converter 110 thereby completing the process loop of ammonia synthesis loop 108. Ammonia 322 may be stored in container 116 for various applications, including the production of fertilizers or energy generation.

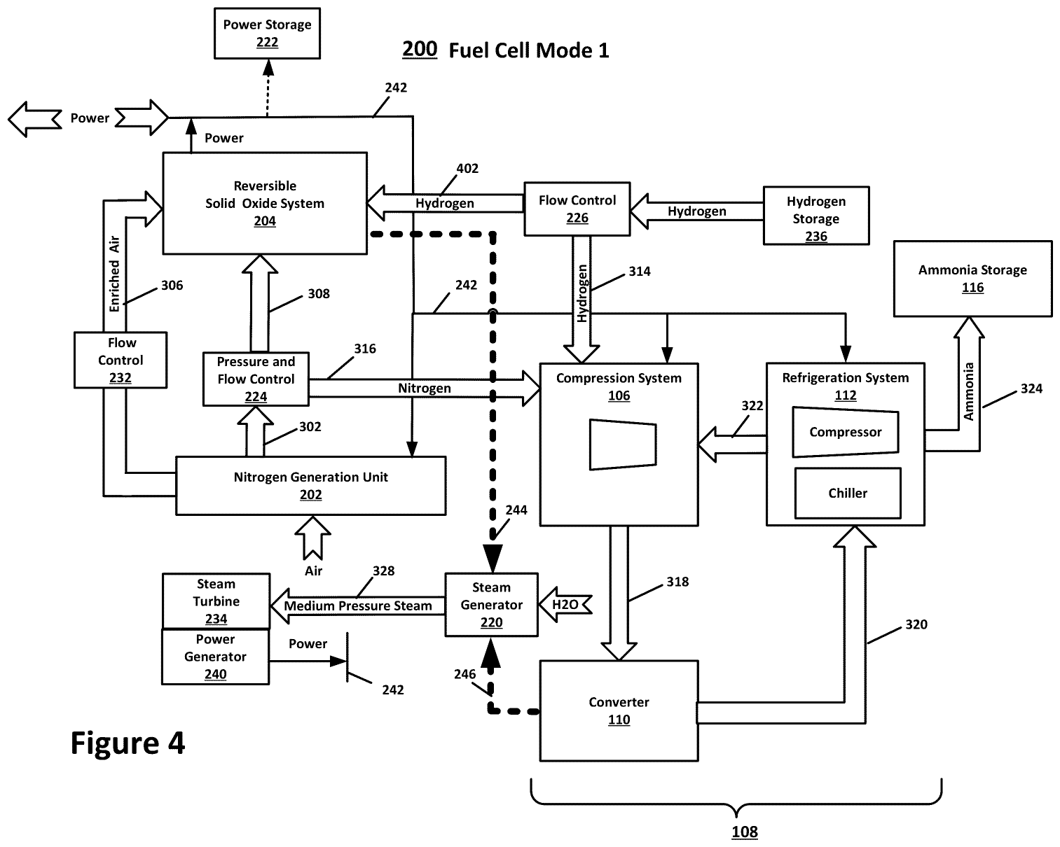

In examples, plant 200 can operate in fuel cell mode. FIG. 4 illustrates an example of plant 200 operating in fuel cell mode in which hydrogen may be converted into electricity by SO system 204. The electricity may be used to synthesize ammonia. Excess electricity can optionally be stored in storage 222. Hydrogen 402 from storage 236 may be supplied to SO system 204 via flow controller 226. In examples, SO system 204 can operate in fuel cell mode and create electricity by reacting hydrogen 402 it receives with oxygen contained within oxygen enriched air 306 provided by nitrogen generation unit 202 via flow controller 232. In the example, electricity generated by the SO system 204 may power one or more of nitrogen generation unit 202, compression system 106, and refrigeration system 112. Excess electricity generated by SO system 204 may be provided to power storage 222 and/or the utility grid. Compression system 106 can be configured to receive feedstock hydrogen 314 from storage 236 via flow controller 226 and/or feedstock nitrogen 316 from nitrogen generation unit 202 via pressure and flow controller 224. The nitrogen gas 316 and hydrogen gas 314 may be mixed and compressed by compression system 106 before it is provided to converter 110. Inside converter 110, nitrogen gas and hydrogen gas can react to form ammonia. The reaction may be exothermic. Heat from the reaction in some examples may be transferred to steam generator 220 through heat transfer system 246, where it may be used to create the steam 328 that drives turbine 234. The reaction mixture, containing ammonia, unreacted nitrogen and hydrogen gases, may be cooled to a lower temperature in refrigeration system 112 to condense ammonia. Liquified ammonia may be separated from the unreacted gases using various separation techniques. The mixture 322 of unreacted nitrogen and hydrogen gases, along with a portion of the produced ammonia, may be recycled back into the converter 110. Ammonia 324 may be stored in container 116 for various applications, including the production of fertilizers or energy generation.

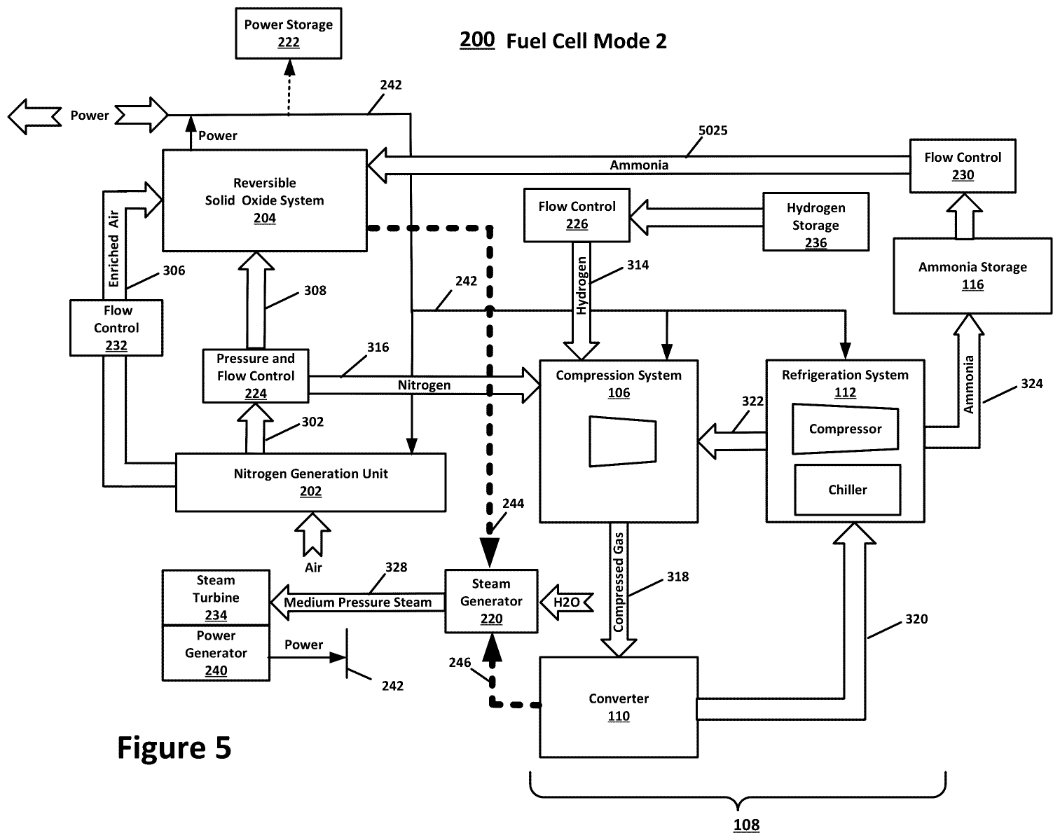

In examples, plant 200 can operate in fuel cell mode using ammonia as the fuel. FIG. 5 illustrates an example of plant 200 operating in a fuel cell mode in which ammonia 502 may be supplied to SO system 204. More specifically, ammonia from storage 116 may be supplied as fuel to SO system 204 via flow controller 230. In examples, the SO system 204 can operate in fuel cell mode and create electricity by, externally to the stack and/or internally in the stack, breaking down the ammonia it receives to hydrogen and reacting the latter with oxygen contained within oxygen enriched air 306 provided by nitrogen generation unit 202 via flow controller 232. Hydrogen provided by storage 236 could be supplied as fuel to SO system 204 for reacting with oxygen along with ammonia during fuel cell mode. In the example, electricity generated by the SO system 204 can power nitrogen generation unit 202, compression system 106, and refrigeration system 112. Excess electricity generated by SO system 204 may be provided to power storage 222 and/or the utility grid. Compression system 106 receives feedstock hydrogen 314 from storage 236 via flow controller 226 and feedstock nitrogen 316 from nitrogen generation unit 202 via pressure and flow controller 224. The nitrogen gas and hydrogen gas may be mixed and compressed by compression system 106 before it is provided to converter 110. Inside converter 110, nitrogen gas and hydrogen gas react and form ammonia. The reaction may be exothermic. Heat from the reaction may be transferred to steam generator 220 through heat transfer system 246, where it may be used to create the steam 328 that drives turbine 234. The reaction mixture 320, containing ammonia, unreacted nitrogen and hydrogen gases, may be cooled to a lower temperature in refrigeration system 112 to condense ammonia. Liquified ammonia 324 may be separated from the unreacted gases using various separation techniques. The mixture 322 of unreacted nitrogen and hydrogen gases, along with a portion of the produced ammonia, may be recycled back into the converter 110. Ammonia may be stored in container 116 for various applications, including the production of fertilizers or energy generation.

When ranges are disclosed herein, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

It is understood that the present subject matter may be embodied in many different forms and should not be construed as being limited to the examples set forth herein. Rather, these examples are provided so that this subject matter will be thorough and complete and will convey the disclosure to those skilled in the art. Indeed, the subject matter is intended to cover alternatives, modifications, and equivalents of these examples. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems), and computer program products according to examples of the disclosure. It will be understood that each block of the flowchart illustrations or block diagrams, and combinations of blocks in the flowchart illustrations or block diagrams, may be implemented by one or more apparatuses that create a mechanism for implementing the functions/acts specified in the block or blocks of the flowchart or block diagram.

The above description sets forth numerous specific details such as examples of specific systems, components, methods, and so forth, in order to provide a good understanding of several examples of the present disclosure. It is to be understood that the above description is intended to be illustrative and not restrictive. Many other examples will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
generating ammonia and heat through a reaction of compressed hydrogen and nitrogen gases;
generating pressurized steam using the heat from the reaction;
supplying the pressurized steam to a turbine to generate electrical power and produce decompressed steam; and
supplying the decompressed steam to a solid oxide electrolysis system to generate oxygen gas and hydrogen gas.

2. A method comprising:
extracting nitrogen from air in a nitrogen generation unit to produce nitrogen gas and oxygen enriched air;
using the oxygen enriched air to adjust a temperature of a reversible solid-oxide system when operated for electrolysis of steam to generate oxygen gas and hydrogen gas; or
using the oxygen enriched air as feedstock to the reversible solid-oxide system when operated in a fuel cell mode.

3. The method of claim 2, further comprising:
compressing a first portion of the nitrogen gas and the hydrogen gas;
generating ammonia and heat through a reaction of compressed first portion of the nitrogen gas and the hydrogen gas; and
supplying a second portion of the nitrogen gas to the reversible solid-oxide system for pressurizing an enclosure of the reversible solid-oxide system containing a plurality of solid-oxide electrolysis cells.

4. The method of claim 3, further comprising a step of:
generating pressurized steam using the heat from the reaction;
supplying the pressurized steam to a turbine to generate electrical power and produce decompressed steam; and
supplying the decompressed steam to the reversible solid-oxide electrolysis system to generate the oxygen gas and the hydrogen gas.

5. The method of claim 4, further comprising a step of:
supplying the electrical power to the reversible solid-oxide system to generate the oxygen gas and the hydrogen gas.

6. The method of claim 4, further comprising a step of:
supplying the electrical power to the nitrogen generation unit to extract the nitrogen from the air.

7. An integrated power to ammonia plant comprising:
a reversible solid-oxide system configured to operate as an electrolyzer to separate steam into hydrogen gas and oxygen gas and configured to operate as a fuel cell to generate electricity;
a nitrogen generation unit configured to extract nitrogen from air and to produce nitrogen gas and oxygen enriched air;
a hydrogen gas storage device to store a first portion of the hydrogen gas, the hydrogen gas storage device configured to supply the first portion of the hydrogen gas to the reversible solid-oxide system to generate the electricity with the oxygen enriched air produced by the nitrogen generation unit;
a compressor configured to produce a compressed mixture of a first portion of the nitrogen gas and a second portion of the hydrogen gas; and
an ammonia generation unit to generate ammonia and heat through a reaction of the compressed mixture.

8. The integrated power to ammonia plant of claim 7, wherein the compressor comprises a motor that is powered by the electricity generated by the reversible solid-oxide system operating as the fuel cell.

9. The integrated power to ammonia plant of claim 7, wherein a second portion of the nitrogen gas is supplied to the reversible solid-oxide system for use in pressurizing an enclosure comprising a plurality of solid-oxide electrolysis cells, and wherein the first and second portions of the nitrogen gas are concurrently supplied to the compressor and the reversible solid-oxide system, respectively.

10. The integrated power to ammonia plant of claim 7, further comprising a battery charged by the electricity generated by the reversible solid-oxide system.

11. The integrated power to ammonia plant of claim 7, further comprising:
a steam generator configured to use a waste heat to heat the steam supplied to the reversible solid-oxide system when operated as an electrolyzer, wherein the waste heat is generated by:
the reversible solid-oxide system while the reversible solid-oxide system is generating the oxygen gas and the hydrogen gas, or
the ammonia generation unit during the reaction of the compressed mixture.

12. A system comprising:
a converter for generating ammonia and heat through a reaction involving a compressed mixture of hydrogen and nitrogen gases;
a steam generator for generating steam using the heat from the reaction; and
a reversible solid-oxide system in fluid communication with the steam generator and configured to separate the steam into oxygen gas and hydrogen gas.

13. The system of claim 12, further comprising:
a turbine in fluid communication with the steam generator and with the reversible solid-oxide system, wherein the turbine is configured to be driven by the steam generated by the steam generator and wherein the reversible solid-oxide system is configured to separate the steam into the oxygen gas and the hydrogen gas after the steam drives the turbine.

14. The system of claim 12, further comprising:
a nitrogen generation unit configured to extract nitrogen from air to produce nitrogen gas and oxygen enriched air.

15. The system of claim 14, further comprising:
first and second fluid transfer structures configured to convey a first portion of the nitrogen gas and the oxygen enriched air from the nitrogen generation unit, respectively, to the reversible solid-oxide system.

16. The system of claim 15, further comprising:
a compressor in fluid communication with the nitrogen generation unit and configured to compress a second portion of the nitrogen gas and a first portion of the hydrogen gas to produce the compressed mixture of the hydrogen gas and the oxygen gas, wherein the nitrogen generation unit is configured to concurrently supply the first and second portions of the nitrogen gas to the reversible solid-oxide system and the compressor, respectively.

17. The system of claim 15, further comprising:
a pressure and flow controller configured to adjust a pressure of the first portion of the nitrogen gas before the first portion of the nitrogen gas is supplied to the reversible solid-oxide system.

18. The system of claim 17, wherein the reversible solid-oxide system comprises an enclosure containing a plurality of solid-oxide cells and an inlet configured to receive the pressure adjusted first portion of the nitrogen gas.

19. An apparatus comprising:
a reversible solid-oxide system configured to separate steam into oxygen gas and hydrogen gas;
a compressor in fluid communication with the reversible solid-oxide system and configured to compress a mixture of hydrogen and nitrogen gases; and
a nitrogen generation unit in fluid communication with the reversible solid-oxide system and the compressor and configured to extract nitrogen from air to produce nitrogen gas and oxygen enriched air, wherein the nitrogen generation unit is configured to supply a first portion of the nitrogen gas to the reversible solid-oxide system and a second portion of the nitrogen gas to the compressor.

20. The apparatus of claim 19, further comprising a pressure and flow controller in fluid communication with the compressor, the nitrogen generation unit, and the reversible solid-oxide system, wherein the pressure and flow controller is configured to adjust a pressure of the first portion of the nitrogen gas before the first portion of the nitrogen gas is supplied to the reversible solid-oxide system.

21. The apparatus of claim 19, further comprising:
a converter for generating ammonia and heat through a reaction involving the compressed mixture of hydrogen and nitrogen gases; and
a steam generator in fluid communication with the reversible solid-oxide system and configured to heat the steam with the heat from the converter before the heat is provided to the reversible solid-oxide system.

22. The apparatus of claim 21, further comprising:
a turbine in fluid communication with the reversible solid-oxide system and with the steam generator, wherein the turbine is configured to be driven by the steam after the steam is heated, and wherein the reversible solid-oxide system is configured to receive the steam after it passes through the turbine.

23. The apparatus of claim 22, further comprising:
a generator configured to be driven by the turbine to generate electrical power; and
an electrical power distribution system electrically connected to the generator and configured to receive the electrical power generated by the generator, wherein the electrical power distribution system is electrically connected to the reversible solid-oxide system and configured to supply electrical power to the reversible solid-oxide system.

24. An apparatus comprising:
a reversible solid-oxide system configured to operate either as an electrolyzer to separate steam into hydrogen gas and oxygen gas, or as a fuel cell to generate electricity;
a nitrogen generation unit configured to extract nitrogen from air to produce nitrogen gas and oxygen enriched air;
a storage device for storing hydrogen gas generated by the reversible solid-oxide system while operating as the electrolyzer; and
a compressor for compressing a mixture of a first portion of the nitrogen gas produced by the nitrogen generation unit and the hydrogen gas generated by the reversible solid-oxide system while operated as the electrolyzer, wherein the reversible solid-oxide system is configured to generate electrical power using hydrogen gas from the storage device when operated as the fuel cell.
